(19) United States
(12) Patent Application Publication
(10) Pub. No.: US 2007/0196151 A1
(43) Pub. Date: Aug. 23, 2007

(54) Electrostatographic apparatus having improved transport member

(75) Inventors: Wayne T. Ferrar, Fairport, NY (US); Douglas E. Garman, Webster, NY (US); Dinesh Tyagi, Fairport, NY (US); Gary B. Bertram, Honeoye Falls, NY (US); Francisco L. Ziegelmuller, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/359,067

(22) Filed: Feb. 22, 2006

(51) Int. Cl. G03G 15/00

(52) U.S. Cl. 399/400

(57) ABSTRACT

The present invention is an electrostatographic reproduction apparatus which includes a primary imaging member for producing an electrostatic latent image on a receiver, a development station for applying toner particles to said latent image which forms a developed toner image on the receiver. A fuser assembly is included for fixing the developed toner image, to form a fused toner image on the receiver. A transport member is provided for transporting the receiver to or from the fuser assembly, the transport member having a substrate bearing an oil-absorbing layer that includes transparent aluminum inorganic particles of pseudo-boehmite, dispersed in an organic binder, and a wax having a melting point less the 100° C.

### FIELD OF THE INVENTION

The present invention relates to electrostatographic image reproduction and, more particularly, to an electrostatographic apparatus that includes a transport web provided with a release oil-absorbing layer.

### BACKGROUND OF THE INVENTION

Electrostatographic printers produce images by transferring polymeric toner particles from a photoreceptor to a receiver and fixing the toner particles to the receiver with heat and pressure. Various additives and oils are used to aid the transfer of the particles. Silicone oil is commonly used as a release oil because it is thermally stable and incompatible with the toner particles and other polymers in the printer; unfortunately, however, it tends to spread throughout the machine as prints are made. Release oil spread is exacerbated by duplex printing, which entails the application of images to both sides of a receiver sheet. Oil provided to the receiver during application of the first image on one side of a receiver is carried into the printer on the paper transport web in the course of applying the second image to the opposite side, leading to objectionable image artifacts such as non-uniform density and differences in gloss. Details of fuser oil application are given in U.S. Pat. Nos. 5,157,445 and 5,512,409, the disclosures of which are incorporated herein by reference.

Ink-jet printers produce images by ejecting droplets of ink onto receivers that absorb ink. Porous coatings of inorganic particles on the receivers improve the image quality by, for example, causing more rapid drying of the ink, reducing image spread, and producing more uniform ink coverage. Silica and alumina particles incorporated into binder polymers are used for coatings on paper and coatings on clear plastics such as polyethylene terephthalate sheets. While larger particles can be used to produce opaque coatings on paper substrates, smaller particles are required for coatings that are transparent in a binder, which is also desirably transparent and colorless. Microporous ink-jet recording elements prepared using psuedo-boehmite in organic polymer matrices are described in, for example, U.S. Pat. Nos. 5,723,211; 5,605,750; 5,085,698; 4,879,166; and 4,780,356, the disclosures of which are incorporated herein by reference.

Similar materials have also been used in electrophotography. U.S. Pat. Nos. 5,406,364 to Maeyama et al. assigned to Canon Kabushiki Kaisha. A cleaner in the form of a web is prepared by immersing a piece of non-woven fabric into a colloidal solution of alumina or silica sol. Poly(vinyl alcohol) may also be added. The patent teaches that porous particles can absorb release agent to clean contaminated surfaces in an electrophotographic apparatus. There is no mention of transparency, nor reference to the size of the oxide particles. The web is used to remove silicone oil from the transfer drum. The coating subjected to repeated charging and discharging in the electrophotographic process thus it does not have to possess insulating properties. Furthermore the material itself is not cleaned of toner from the electrophotographic process and, therefore, does not have to possess a low surface energy.

U.S. Pat. No. 5,903,802 to Watanabe also of Cannon uses pseudo-boehmite particles as well as silica particles, porous ceramics and foamed metals to clean transfer members and photoreceptors. Release agent absorbing layers are placed in various parts of the electrophotographic apparatus such as the feed passage member. Particle size is not important because there is no requirement for the layer to be transparent, nor is the coating subjected to repeated charging and discharging in the electrophotographic process. Furthermore the material itself is not cleaned of toner from the electrophotographic process and therefore does not have to possess a low surface energy.

Pseudo-boehmite coatings have also been applied to the photoreceptors used in electrophotographic printing. U.S. Pat. No. 5,693,442, the disclosure of which is incorporated herein by reference, describes the incorporation of a nickel metallized dye into an overcoat of pseudo-boehmite to act as a filter to protect the light sensitive element. The inorganic particles and 5 wt. % of the metallized dye in a poly(vinylpyrrolidone) binder form a transparent layer that can be charged under a corona charger and discharged by exposure to actinide radiation.

The mitigation of objectionable image artifacts such as non-uniform density and differences in gloss that result from the spread of release oil from an imaged receiver into the reproduction apparatus, particularly during a duplex printing process, is provided by the present invention.

### SUMMARY OF THE INVENTION

The present invention is an electrostatographic reproduction apparatus which includes a primary imaging member for producing an electrostatic latent image on a receiver, a development station for applying toner particles to said latent image which forms a developed toner image on the receiver. A fuser assembly is included for fixing the developed toner image, to form a fused toner image on the receiver. A transport member is provided for transporting the receiver to or from the fuser assembly, the transport member having a substrate bearing an oil-absorbing layer that includes transparent aluminum inorganic particles of pseudo-boehmite, dispersed in an organic binder, and a wax having a melting point less the 100° C.

### BRIEF DESCRIPTION OF THE DRAWINGS

FIG. 1 is a schematic side elevational view of an electrostatographic reproduction apparatus that includes an endless web transport member for moving a receiver to and from a fuser assembly;

FIG. 2 is a plot of release oil on a transport web versus the number of duplexed contacts obtained using a standard PET web; and

FIG. 3 is a plot of release oil on a transport web versus the number of duplexed contacts obtained using a web containing an oil-absorbent coating in accordance with the present invention.

### DETAILED DESCRIPTION OF THE INVENTION

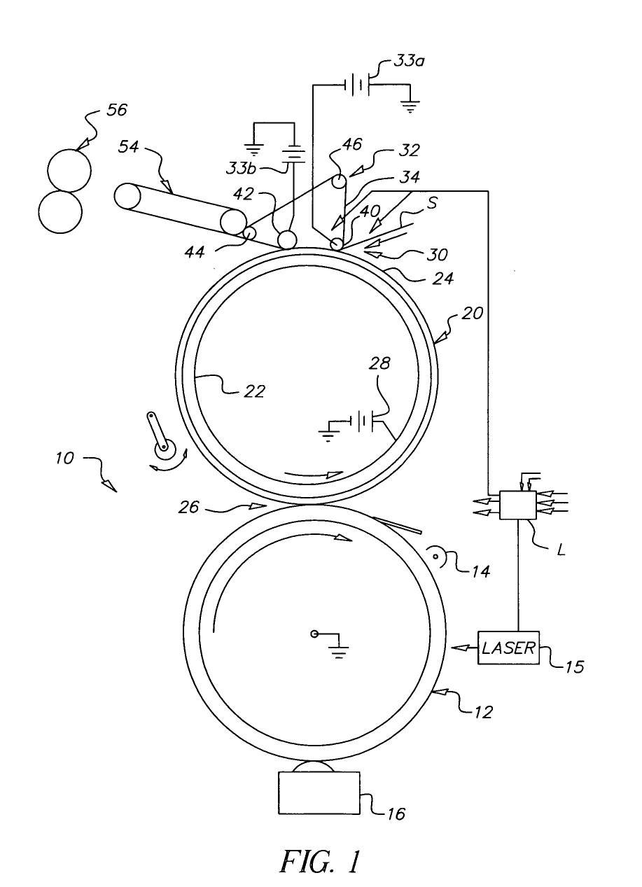

FIG. 1 shows an exemplary image-forming electrostatographic reproduction apparatus, designated generally by the numeral 10, that includes a primary image-forming member, for example, a drum 12 having a photoconductive surface, upon which a pigmented marking particle image, or a series of different color marking particle images, is formed. To form images, the outer surface of drum 12 is uniformly charged by a primary charger such as a corona charging device 14, and the uniformly charged surface is exposed by suitable exposure device such as a laser 15 to selectively alter the charge on the surface of the drum 12, thereby creating an electrostatic image corresponding to an image to be reproduced. The electrostatic image is developed by application of pigmented marking particles to the image bearing photoconductive drum 12 by a development station 16 that may include from one to four (or more) separate developing devices.

The marking particle image is transferred (or multiple marking particle images are transferred one after another in registration) to the outer surface of a secondary or intermediate image transfer member, for example, an intermediate transfer drum 20 that includes a metallic conductive core 22 and a compliant layer 24 that has relatively low resistivity. With such a relatively conductive intermediate image transfer member drum 20, transfer of the single color marking particle images to the surface of drum 20 can be accomplished with a relatively narrow nip 26 and a relatively modest potential applied by potential source 28.

A single marking particle image, or a multicolor image comprising multiple marking particle images respectively formed on the surface of the intermediate image transfer member drum 20, is transferred in a single step to a receiver S, which is fed into a nip 30 between intermediate image transfer member drum 20 and a transfer backing member 32. The receiver S is fed from a suitable receiver member supply (not shown) into nip 30, where it receives the marking particle image. Receiver S, exits nip 30 and is transported by a transport web 54 to a fuser assembly 56, where the marking particle image is fixed to receiver S by application of heat and/or pressure. Receiver member S bearing the fused image is transported by transport web 54 to a storage location (not shown) or is inverted by a mechanism (not shown) for transfer of a second image to the reverse side of receiver S.

A transfer-backing member 32 that includes an endless support 34 is entrained about a plurality of support members, for example rollers 40, 42, 44, and 46. Support roller 42 is electrically biased by potential source 33b to a level sufficient to efficiently urge transfer of marking particle images from intermediate image transfer member drum 20 to receiver member S. At the same time, support roller 40 is electrically biased, for example to ground potential, or electrically connected to source 28 or a separate potential source 33a, to a level sufficient to eliminate ionization and premature transfer upstream of nip 30.

Appropriate sensors (not shown) of any well known type are utilized in reproduction apparatus 10 to provide control signals for apparatus 10, which are fed as input information to a logic and control unit L that produces signals for controlling the timing operation of the various electrographic process stations.

To facilitate release of the fixed toner image from fuser assembly 56, a release agent such as silicone oil is applied to imaged receiver S by a mechanism such as depicted in FIG. 1 of the previously cited U.S. Pat. No. 5,157,445. As already noted, an excess of this oil can be carried to other parts of apparatus 10, especially in the course of duplex printing, resulting in objectionable image artifacts.

In accordance with the present invention, a transport member in an electrostatographic reproduction apparatus 10, depicted in FIG. 1, includes a release oil-absorbing layer disposed on a substrate. Although the transport member is exemplified as a continuous web 54 in FIG. 1, it may take other forms such as, for example, a drum or roller. Apparatus 10 further includes a primary image-forming member, which is exemplified in FIG. 1 as a drum 12 but may be constructed in another form such as, for example, a roller or a belt. The reproduction apparatus optionally includes, operationally associated with the primary image-forming member, an intermediate image transfer member, which is depicted in FIG. 1 as a drum 20 but may also be constructed in another form such as, for example, a roller or a belt.

A transport member provided with an oil-absorbing layer in accordance with the present invention may be included in a full color reproduction apparatus having four toner development stations for cyan, magenta, yellow, and black, as depicted in FIG. 8 of U.S. Pat. No. 6,075,965, the disclosure of which is incorporated herein by reference. A developed multicolor image, following fixing by a fuser assembly, can be transported to a storage site or circulated back for recording an image on the opposite side of the receiver, as described in U.S. Pat. No. 6,184,911, the disclosure of which is incorporated herein by reference.

Charge is repeatedly applied to the surface of the transport member in every imaging cycle at each of the transfer nips. The transport web is reconditioned in each cycle by providing charge to both surfaces by opposed corona chargers 522, 523 in FIG. 8 of U.S. Pat. No. 6,075,965. An additional corona charger 524 provides negative charge of approximately 600-900 V to tack down of the paper or receiver to the transport web thus preventing the receiver from moving as it goes through the electrophotographic process. After transfer of the toner image to the receiver, the receiver is conveyed on the transport web to a nip where an electrical bias is applied so the receiver can be detacked and fed into a fuser station. Additionally the web is imaged with various colored toners that are used for process control of image density and registration. Thus, it is important that the transport member have insulating properties that allow for efficient charging and for the maintenance of the charge throughout the electrophotographic cycle. If the resistivity of the transport member decreases due to high humidity, the image quality of the process is compromised. In general poly(ethylene terephthalate) is one of the preferred substrates for the transport member because it has a good insulating properties. It would be desirable that any coating on the transport member maintain similar insulating properties.

It is also important that the layer be transparent or translucent so that sensors for process control can be used to monitor toner density and image registration. These sensors can work by passing light through the coated transport web to a detector on the opposite side or by reflecting the light back to a detector mounted above the sensor. The light may be reflected by a separate reflector after the light has passed through the web, or by the support itself.

The previous inventions described the addition of the fluorosurfactant ZONYL™ FSN to aid in cleaning of toner from the transport web surface. However, ZONYL™ FSN is composed from ethylene glycol with a fluorocarbon, and when this surfactant is combined with pseudo-boehmite and poly(vinyl alcohol), the resistivity of the coating has been found to decrease especially at high humidity. This results in a number of undesirable properties such as poor tack down of the paper or receiver to the transport web because the conductive ZONYL™ FSN surfactant provides a pathway for the charge to dissipate. The charge was deliberately place on the web by the web charger in order to hold the receiver in place and allow for imaging with toner for process control purposes and an image with poor quality can result from the charge dissipation.

This invention incorporates low melting waxes in place of fluorosurfactants that act as lubricants to facilitate cleaning of the transport web by a polyurethane blade after the web is deliberately discharged with a separate device. The waxes do not contain the ethylene glycol or similar structures that make the ZONYL™ FSN conductive, but do provide a low surface energies and, therefore, have the potential to act as cleaning aids for the web that are not as affected by the environment around them.

The inorganic particles included in the oil-absorbing layer preferably include compounds of aluminum selected from the group consisting of alumina hydrate, aluminum oxide, pseudo-boehmite, boehmite alumina, and mixtures thereof. More preferably, the inorganic particles include the alumoxane psuedo-boehmite, a xerogel of boehmite represented by the chemical formula Al(O)OH. Pseudo-boehmite can be prepared by procedures described in, for example, U.S. Pat. Nos. 4,120,943 and 5,723,211, the disclosures of which are incorporated herein by reference. The pore characteristics of the xerogel vary depending upon the size and shape of the boehmite colloidal particles. If pseudo-boehmite having a large particle size is used, a layer having a large pore size can be obtained. However larger particles scatter light to various degrees. Smaller particles have smaller pores than the larger particles and tend to be transparent. Smaller particles with a dispersed particle size of less than 0.5 micron are used for this invention so the porous layers are transparent or translucent.

An organic binder is employed in the oil-absorbing layer to impart mechanical strength to it. The pore characteristics and transparency of the oil-absorbing layer depend on the particular binder employed. Suitable binders include organic materials such as, for example, starch or one of its modified products, poly(vinyl alcohol) or one of its modified products, cellulose derivatives, ether-substituted poly(phosphazenes), ether-substituted acrylates, ethylene oxide-vinyl alcohol copolymers, poly(vinyl butyral), poly(vinyl formal), polyoxazolines, aliphatic polyamides, and poly(vinylpyrrolidone). A major factor in the choice of the binder is that it is compatible with porous alumina particles and results in a transparent or translucent layer. The binder, preferably poly(vinyl alcohol), is present in an amount, based on the amount of inorganic particles, of preferably about 3 wt. % to about 30 wt. %, more preferably, about 5 wt. % to about 25 wt. %. If the amount of binder is less than about 3 wt. %, the strength of the oil-absorbing layer tends to be inadequate. On the other hand, if it exceeds 30 wt. %, its porosity tends to be inadequate. Coatings made of the dispersed pseudo-boehmite of less than 0.5 micron on transparent substrates are clear to translucent, and therefore allow for the process control sensors to operate effectively.

The release oil-absorbing layer of the present invention preferably has a dried thickness of about 1 μm to about 50 μm, more preferably, about 2 μm to about 40 μm. Optionally, the oil-absorbing layer can also incorporate various known additives, including surfactants, pH controllers, anti-foaming agents, lubricants, preservatives, viscosity modifiers, waterproofing agents, dispersing agents, UV absorbing agents, mildew-proofing agents, mordants, crosslinking agents such as boric acid or borax, and the like, with the proviso that the additive does not greatly decrease resistivity or the transparency of the layer. The oil-absorbing layer can also include matting agents such as matte beads comprising crosslinked polystyrene, crosslinked polyacrylate, or polytetrafluoroethylene (TEFLON™) and having a diameter preferably between about 1 μm and about 30 μm, more preferably between about 2 μm and about 20 μm.

A web substrate for the oil-absorbing layer can be reflective, translucent, or transparent and can have a thickness of, preferably about 50 μm to about 500 μm, more preferably, about 75 μm to about 300 μm. The web substrate must either allow light to pass through or be reflective. Poly(ethylene terephthalate) (PET) is a preferred substrate. Other clear semi-crystalline substrates such as poly(ethylene naphthalate) (PEN) are also thought to be useful. Antioxidants, antistatic agents, plasticizers, and other known additives may be optionally incorporated in the web substrate.

The adhesion of the oil-absorbing layer to the substrate can be improved by corona-discharge treatment of the substrate surface prior to application of the oil-absorbing layer. Alternatively, an undercoating or subbing layer formed from a halogenated phenol or a partially hydrolyzed vinyl chloride-vinyl acetate copolymer and having a thickness (i.e. a dry coat thickness) preferably of less than 2 μm can be applied to the surface of the substrate.

Optionally, an additional backing layer or coating may be applied to the backside of the web substrate, i.e., the side of the substrate opposite the side bearing the oil-absorbing layer, to improve the machine-handling properties of the transport web and controlling the friction and resistivity thereof. Typically, the backing layer includes a binder and a filler, which can be, for example, amorphous and crystalline silicas, poly(methylmethacrylate), hollow sphere polystyrene beads, microcrystalline cellulose, zinc oxide, talc and the like. The filler included in the backing layer is generally less than 2 wt. % of the binder, and the average particle size of the filler material is in the range of 5 μm to 15 μm. Typical of the binders used in the backing layer are polymeric materials such as gelatin, chitosan, acrylates, methacrylates, polystyrenes, acrylamides, poly(vinyl alcohol), poly(vinylpyrrolidone), poly(vinyl chloride)-co-poly(vinylacetate), SBR latex, NBR latex, and cellulose derivatives.

To form the release oil-absorbing layer on a substrate, a binder is added to the inorganic particles to obtain a slurry, which is coated on the substrate using, for example, a roll coater, an air knife coater, a blade coater, a rod coater, a bar coater, or a comma coater, and then dried. Preferred coating compositions for the oil-absorbing layer contain pseudo-boehmite and poly(vinyl alcohol) in a weight ratio of about 3:1 to about 20:1.

Fluorosurfactants are useful as cleaning aids for inclusion in the oil-absorbing layers, serving to facilitate the removal of toner particles from the surface of the coated substrate as described in U.S. Ser. No. 10/965,369. The addition of the fluorosurfactant ZONYL™ FSN, a water-soluble, ethoxylated nonionic fluorosurfactant, to the oil-absorbing layer enables the removal of toner particles that are not readily removed in the absence of the surfactant. The oil-absorbing layer includes the fluorosurfactant preferably in an amount of about 0.01 wt. % to about 10 wt. %, more preferably, about 0.02 wt. % to about 6 wt. %, of the total amount of inorganic particles and organic binder.

Like most surfactants that are intended for aqueous applications, ZONYL™ FSN consists of about half a hydrophobic tail and half a hydrophilic portion. The hydrophobic portion consists of a short fluorocarbon chain CₙF₂ₙ₊₁. The hydrophilic portion consists of an ethylene glycol chain (C₂H₄O)ₘ. The pure material is a greasy, tan solid with a melting point of 30° C. that is typically at levels of 0.01 to 0.1% by weight when used as a surfactant coating aid. However in this invention the ZONYL™ FSN serves as a lubricant to assist the polyurethane blade in cleaning of the toner from the surface of the transport web. Optimal properties are obtained when the ZONYL™ FSN is added at 6 parts by weight to the pseudo-boehmite/poly(vinyl alcohol) layer, which corresponds to about 5.7 weight % ZONYL™ FSN in the porous layer. Thus the level of the hydrophilic ethylene glycol in the layer is relatively high. The presence of ethylene glycol in the film is undesirable because it makes the overcoat more sensitive to humidity changes. At low humidity the porous layer is dry. This allows for easy charging of the transport web and results in good paper tack down and good image registration and process control from imaging on the transport web. Measurement of the surface resistivity of the porous layer gives a good indication of how well the coated transport webs will hold a charge. The surface resistivity can be measured using a Keithley electrometer. A 10 micron thick coating of the pseudo-boehmite/PVA over the PET transport web had surface resistivity of 1.7×10¹⁰ ohm/sq at 60° F./20% RH. The sample contained only 0.02% ZONYL™ FSN as a coating aid. In contrast, a 10 micron coating of the same material but with the ZONYL™ FSN at 5.7 wt. % (6 parts) had a surface resistivity of 1.8×10¹⁰ ohm/sq under the same conditions, an order of magnitude more conductive. The same trend is observed at high humidity, 80° F./70% RH, where the sample with a surfactant level of ZONYL™ FSN had a resistivity of 1.7×10¹⁰ ohm/sq and the sample with 5.7% ZONYL™ FSN had a resistivity of 6.0×10⁹ ohm/sq. The detrimental effect of ethylene glycol causing the increase in the conductivity is probably not only due to the hydroscopic nature of the material, but also to the large dielectric constant. Antistatic properties of similar molecules where ethylene glycol has been grafted to siloxane and phosphazene moieties have been reported in U.S. Pat. Nos. 4,610,955 and 5,174,923, respectively. These molecules are surface active, as is the ZONYL™ FSN, and lower the surface resistivity of photographic emulsions. The photographic antistats also have a low lattice energy salt associated to the ethylene glycol portion of the molecule which acts as the charge carrier. In this current invention, the pseudo-boehmite contains acidic ions at the surface of the particles to stabilize the emulsion in which they are made. These molecules are either nitric or acetic acid, as described by U.S. Pat. No. 5,264,275. Thus it would be advantageous to replace the ZONYL™ FSN with another molecule that did not lower the resistivity of the porous layer. Transport webs coated with organic waxes in place of ZONYL™ FSN have higher surface resistivity. ZONYL™ FSN is a waxy substance with a melting point about 30° C. Two types of hydrophobic waxes have been useful as cleaning aides in pseudo-boehmite porous transport belts, WE waxes from NOF Corporation, and Camauba wax.

WE waxes are fatty acid esters formed from long chain fatty acid and alcohols. They are high purity solids characterized by narrow melting ranges, low endothermic energy for melting, and high thermostability. The WE waxes useful for this invention have melting points below 100° C., which is below the 120° C. temperature used to dry the films in the coating process. Thus the waxes do not block the pores of the pseudo-boehmite because the films are dried above the melting points of the waxes. The waxes can be made into aqueous emulsions or are soluble in organic solvents. This means the waxes can be placed in the pseudo-boehmite coating solution or coated over the top of the porous layer in a separate step.

The melting properties of the waxes is thought to be important in preparing samples where the alumina is covered by the wax, but the pores are available to absorb oil. This is demonstrated by the experiment of coating Teflon™ AF, a fluoropolymer available from DuPont and soluble in organic solvents, over the surface of the pseudo-boehmite transport web. Teflon™ AF does not decrease the resisitivity of the transport web. It does not contain a polyethylene glycol moiety. Unfortunately overcoating the Teflon™ AF onto the web destroys the oil absorbing properties of the pseudo-boehmite layer by blocking the pores on the surface. The Teflon™ AF fails to melt and then flow into the pores so that only the high surface energy alumina particles are covered with the low surface energy fluorocarbon, but instead leaves a continuous film that is not useful as a transport web additive. Other polymers coated on the pseudo-boehmite layer behave in much the same way, blocking the pores of the film and thus negating any beneficial effects of making the surface of the film less susceptible to decreasing resistivity with increasing humidity.

Another wax that has beneficial properties is Camauba wax, which has a melting point of about 80° C. Carnauba is a natural wax derived from fronds of a Brazilian palm tree. The material improves slip, mar resistance and block resistance. It is available as an aqueous emulsion from Michelman, Inc.

While not wanting to be bound by the following theory, it is thought that the role of the wax is to cover the alumina particles. Inorganic oxides have high surface energies. This makes cleaning of the toner deposited on the web during process control very difficult. As described in the previous U.S. Ser. No. 11/043,774, the pseudo-boehmite is effectively covered by the ZONYL™ FSN wax, acting to give a surface that is easily cleaned in a manner similar to Teflon™ coating on a non-stick cook pan. This invention requires that a polyurethane blade is used to clean the toner from the porous layer, and thus the porous layer must have a low surface energy. This can be observed by surface analysis of the samples with X-ray photoelectron spectroscopy (XPS). A transparent coating on PET of the pseudo-boehmite and poly(vinyl alcohol) with a small amount of ZONYL™ FSN (0.02 wt. %) added as a coating aid had almost 26 atom % of the aluminum on the surface. A sample that contained a large amount of ZONYL™ FSN (5.7 wt. %) as a cleaning aid had 23 atom % aluminum at the surface. Finally a sample that had the small amount of ZONYL™ FSN but was overcoated with a thin layer of WE-5 wax had only 14 atom % of aluminum remaining on the surface. All three of the samples had approximately the same level of oil absorption.

TABLE 1
Surface Composition in Atom %

| Sample | | C1s | A12p | O1s | N1s | F1s |
|---|---|---|---|---|---|---|
| RC5-9560-A | Base coating | 13.88 | 25.87 | 59.29 | 0.33 | 0.63 |
| RC5-9560-A | base coating + | 13.27 | 22.38 | 55.28 | 0.20 | 8.87 |
| | 5.7% | | | | | |
| | ZONYL ™ FSN | | | | | |
| RC5-9396-5 | 0.5% WE-5 wax | 43.79 | 14.30 | 41.91 | none | none |
| | solution over base | | | | | |
| | coating | | | | | |

Another useful method to examine the surface of a coating is the use of fluids to determine the surface energies. This technique involves placing a drop of a non-intereacting fluid on the sample and measuring the angle between the surface of the drop and the surface of the sample. A low contact angle indicates a high surface energy because the fluid has spread. Conversely a high contact angle indicates that the sample has a low surface energy because the fluid has formed a bead. One would expect that a good analogy for wax on the pseudo-boehmite surface would be the formation of rain drops on a freshly waxed car, with a high contact angle being observed by placing a drop of water on the coating. While in some sense this is true, the observation is complicated by the fact that the pseudo-boehmite surface is porous and maintains that porosity after the wax is placed on the surface and melted into the pores in the coating machine dryers. Making the measurement is difficult because the drop is rapidly absorbed into the coating and the contact angle changes rapidly with time. Additionally the surfaces of these coatings are rough, preventing the drops from obtaining an equilibrium position. The presence of the low levels of ZONYL™ FSN surfactant used as a coating aid also have a large effect on the surface energy, especially of a fresh film that has not been in a printer. We have found however that using release oil from the electrophotographic printer is a useful fluid to measure contact angles. The release oils are poly(dimethylsiloxane) macromolecules that may be modified with various functional groups such as amines or ethylene oxides. By making several measurements at a specified time on each sample before the drop is absorbed into the coating, a contact angle between 20 and 40 is generally obtained for these wax containing pseudo-boehmite samples.

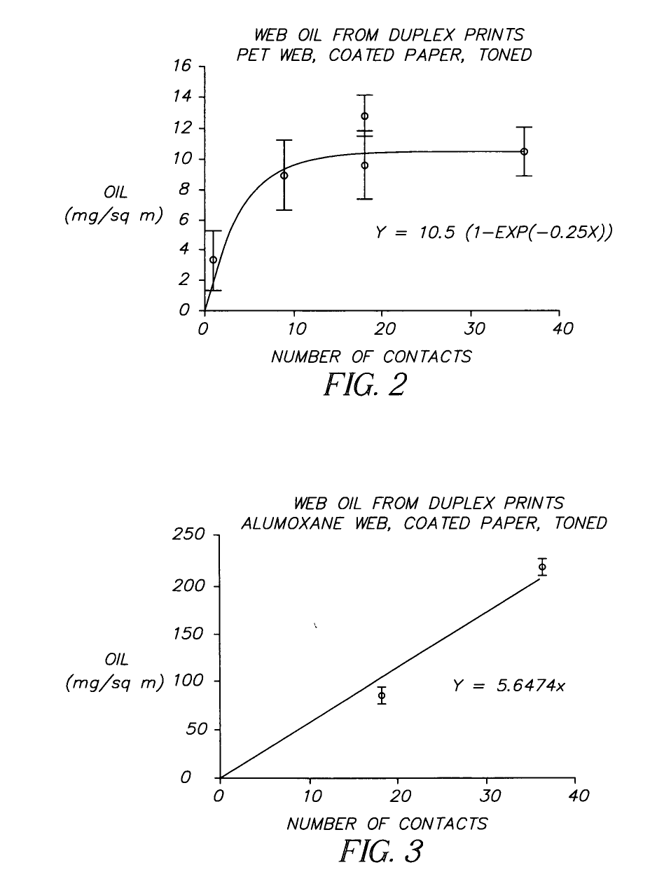

When printing duplex images on certain described reproduction apparatus, release oil that had been applied to an imaged receiver transfers to the transport web from sheets that are to be printed on the second side. Comparison measurements of oil concentrations as a function of duplex run lengths have been carried out on standard uncoated paper transport webs and on webs provided with an oil-absorbing layer in accordance with the present invention. As shown by the plot in FIG. 2, the oil concentration on a standard uncoated PET web reaches an equilibrium level within 18 duplex contacts (198 duplexed tabloid sheets). The equilibrium level for oil transfer is 16 times higher from toned areas than for untoned areas, which presumably is the origin of the oil artifact. By comparison, paper transport webs provided with an oil-absorbing layer show a linear increase in oil concentration up to the maximum test run of 36 contacts (396 duplexed tabloid sheets) for transfer of oil from toned areas, as shown by the plot in FIG. 3. At this point, the absorbed oil concentration for the transport web of the present invention is 20 times the equilibrium concentration for the standard web. These results indicate that the oil-absorbing coating provides protection from oil artifacts by drawing oil into the porous interior of the coating, reducing the amount of oil available at the surface for transfer to other parts of the machine. On the basis of this mechanism, the useful life of a web would depend on the oil capacity of the coating, which would be expected to depend on the coating thickness. The effective lifetime of a coating can be predicted based on its estimated capacity and the measured oil take up rate.

Oil taken up by the PET web from both toned and untoned areas appears to follow exponential patterns represented by general equation y=a(1−e^{-bx}), reaching an equilibrium level after a small number of contacts. Oil from toned paper on the web provided with an oil-absorbing layer increases approximately linearly with the number of contacts over the range of the experiments (using (0,0) as an assumed “data” point). It is suspected that this apparent linear behavior is the low end of an exponential curve that is far from the equilibrium level. In conclusion, important properties of the wax containing pseudo-boehmite transport webs include:

High resistivity to prevent charge from bleeding from the surface and decreasing the tackdown force of the receiver to the web (10¹⁰ to 10¹⁴ ohms/sq).

High porosity for the absorption of the fuser fluid from the receiver to prevent the fluid from spreading to other components and causing image artifacts (200 to 350 mg/m²/μm).

Coverage of the hydrated alumina oxide particles, as determined with XPS, which make removal of toner particles from the web difficult (an aluminum 2p relative atom percent coverage of from 10 to 25).

Surface energies that are lowered by the waxes to allow for cleaning of the film (contact angle with release oil of from 20 to 40 degrees).

The present invention is further illustrated by the following examples, but it should be understood that the invention is not in any way restricted to such examples.

### EXAMPLES

Pseudo-boehmite particles were obtained from Sasol North America, Inc of Houston, Tex. under the trade name of DISPAL™ 18N4-80. The particles had a dispersed particle size of 110 nanometers. A 25 wt. % pseudo-boehmite dispersion was prepared from 90 g of DISPAL™ 18N4-80 alumina particles to 270 g of stirred deionized water. A 10 wt. % poly(vinyl alcohol) solution was prepared in a ratio of 10 g poly(vinyl alcohol) powder (KH-20 GOHSENOLM, Nippon Gohsei) to 90 g stirred deionized water, and heating the mixture to 80° C. for 1 hour to produce a clear, viscous solution. The solutions were mixed and the appropriate amount of ZONYL™ FSN surfactant (40 wt. % active in isopropanol/water) was added as a coating aid (0.01 to 0.02 wt. %) or at various increments up to 6 parts by weight of the solid (5.7 wt. %). The white dispersion was coated, using an extrusion hopper, over a subbing layer of acrylonitrile-vinyl chloride-acrylic acid on one side of a 102 μm-thick polyethylene terephthalate film and dried at temperatures up to 120° C. for 20-30 minutes. The coatings were flexible, clear, transparent films that were formed into loops by ultrasonic sealing with the coating on the outside of the loop.

Web voltage readings are taken by placing an electrometer on the web after it has been charged to tack down the receiver. The current Nexpress PET transport web has 750 Volts remaining on the web after 30 seconds. Receiver Tack Down readings are obtained by stopping the Nexpress 2100 printer immediately after paper has been tacked down on the web, and pulling on the paper in a tangential direction to remove it from the web. A Receiver Tack Down value of 10 is assigned for the amount of force to remove the receiver from the P1 web. Values for the pseudo-boehmite coated webs are compared to the P1 web by estimating the amount of force needed to remove the receiver from the web. The receiver is 118 gram LustroGloss. A polyurethane blade is used to clean the toner from the porous layer.

Table 2 shows that high ZONYL™ FSN (6 parts) cause the voltage to decay faster and the receiver tack down to the web to decrease as the humidity is increased.

TABLE 2

| | | | | | | Receiver Tack | |
|---|---|---|---|---|---|---|---|
| | | Parts | | | Voltage | Down | Cleaning |
| Coating | | ZONYL ™ | | Temp | after | (Pull | Of |
| # | Binder | FSN | Cure | (° F.)/RH | 30 sec | Force) | Toner |
| 1 | KH20 | 6 | None | 70/20 | −300 | 7 | good |
| 1 | KH20 | 6 | None | 60/45 | −180 | 3 | good |
| 1 | KH20 | 6 | None | 70/45 | −140 | 4 | good |
| 1 | KH20 | 6 | None | 80/45 | −160 | — | good |
| 1 | KH20 | 6 | None | 70/70 | −160 | 1 | good |

Table 3 shows that increasing ZONYL™ FSN content causes the voltage to decay faster and the receiver tack down to the web to decrease, although the cleaning is improved to remove all the toner. In contrast, low levels of ZONYL™ FSN result in poor cleaning.

TABLE 3

| | | | | | | Receiver Tack | |
|---|---|---|---|---|---|---|---|
| | | Parts | | | Voltage | Down | Cleaning |
| Coating | | ZONYL ™ | | Temp | after 30 | (Pull | Of |
| # | Binder | FSN | Cure | (° F.)/RH | sec | Force) | Toner |
| 2 | KH20 | 2 | none | 73/44 | −580 | 6 | poor |
| 3 | KH20 | 4 | none | 73/44 | −360 | 6 | moderate |
| 4 | KH20 | 6 | none | 73/44 | −320 | 5 | good |

Table 4 shows that curing the web causes the web to maintain its voltage. However the effect in not long lived and the receiver tack down is poor after long exposure to high humidities. Additionally, receiver tack down did not improve with higher voltage, although this could be a function of the low humidity.

TABLE 4

| | | | | | | Receiver Tack | |
|---|---|---|---|---|---|---|---|
| | | Parts | | | Volts | Down | Cleaning |
| Coating | | ZONYL ™ | | Temp | after 30 | (Pull | Of |
| # | Binder | FSN | Cure | (° F.)/RH | sec | Force) | Toner |
| 1 | KH20 | 6 | none | 75/23 | −300 | 8 | good |
| 1 | KH20 | 6 | 20 hr | 75/23 | −500 | 8 | N/A |
| | | | @ | | | | |
| | | | 90 C. | | | | |
| 5 | KH20 | 0.02 | none | 75/23 | −800 | — | poor |
| 5 | KH20 | 0.02 | 68 h | 79/46 | −950 | — | poor |
| | | | @ | | | | |
| | | | 90 C. | | | | |

Table 5 shows that a web with almost no ZONYL™ FSN has higher residual voltage than a web with 6% ZONYL™ FSN.

TABLE 5

| | | | | | | Receiver | |
|---|---|---|---|---|---|---|---|
| | | | | | | Tack | |
| Coat- | | | | Temp | Volts | Down | Cleaning |
| ing | | % | | (° F.)/ | after | (Pull | Of |
| # | Binder | FSN | Cure | RH | 30 sec | Force) | Toner |
| 6 | Elvanol | 0.02 | none | 80/50 | −1080 | — | poor |
| 7 | Elvanol | 6 | none | 80/50 | −200 | — | good |

Transport webs coated with organic waxes in place of ZONYL™ FSN have higher surface resistivity. Table 6 shows the surface resistivity for approximately 10 micron coatings of pseudo-boehmite/PVA on the PET transport webs. The waxes are aqueous emulsions much like ZONYL™ FSN is an alcohol solution that is water soluble. This means the waxes can be placed in the pseudo-boehmite coating solution or coated over the top of the porous layer in a separate step. The surface resistivity was measured using a Keithley 6517 Electrometer/High Resistance System and Keithley 8009 Resistance Test Fixture. The samples were kept at constant temperature and humidity overnight in a Tenney Six Chamber and each sample removed separately immediately before testing. The samples were approximately 7×7 cm squares. WE waxes were obtained as aqueous emulsions and solid powders from Nagase America Corporation, distributors for NOF Corporation, Japan, 546 Fifth Ave, New York, N.Y. Camauba wax emulsion was obtained form Michelman, Inc., Cincinnati, Ohio, 45236-1299. Contact angles to determine surface wetting with silicon oil were taken by placing a drop of silicone oil fuser release fluid onto the film and marking immediately with a goniometer to negate the absorption of the drop into the coating. The samples typically range in the 30 degree range, due to a combination of the ZONYL™ FSN coating aid, the poly(vinyl alcohol) binder, and the wax overcoat.

TABLE 6
Aqueous Coating Of Porous Alumina and Wax (90 parts 18N4-80 + 10 parts KH-20)

| | | | | | | Surface | Surface | |
|---|---|---|---|---|---|---|---|---|
| | | Aim | | | Specific | Resistivity | Resistivity | Release Oil |
| | | Coverage | Total | | Capacity | (ohm/sq) | (ohm/sq) | Contact |
| Coating | Description | of Layer | Thickness | Oil Capacity | (mg/sq | (60° F./20% | (80° F./70% | Angle |
| Number | of Wax | (microns) | (microns) | (mg/sq m) | m/micron) | RH) | RH) | (degrees) |
| NexPress | Polyethylene | 0 | 0 | 0 | 0 | >10¹⁴ | >10¹⁴ | |
| Web | terephthalate | | | | | | | |
| 8 | base coating | 15.0 | 9.8 | 2790 | 284.7 | 1.7 × 10¹¹ | 1.7 × 10¹⁰ | 38.7 |
| | (0.02% | | | | | | | |
| | ZONYL ™ | | | | | | | |
| | FSN) | | | | | | | |
| 9 | base coating + | 15.0 | 10.0 | 2360 | 236.0 | 1.8 × 10¹⁰ | 6.0 × 10⁹ | 31.5 |
| | 5.7% | | | | | | | |
| | ZONYL ™ | | | | | | | |
| | FSN | | | | | | | |
| 10 | base coating + | 15.0 | 9.0 | 2330 | 258.9 | 1.8 × 10¹¹ | 6.6 × 10¹⁰ | 35.8 |
| | 0.5% WE-5 | | | | | | | |
| | wax | | | | | | | |
| 11 | base coating + | 15.0 | 12.0 | 3700 | 308.3 | 1.1 × 10¹¹ | 3.0 × 10¹⁰ | 37.3 |
| | 0.5% WE-6 | | | | | | | |
| | wax | | | | | | | |
| 12 | 0.5% WE-5 | 0.25 | 9.0 | 2440 | 271.1 | 2.0 × 10¹¹ | 7.0 × 10¹⁰ | 34.9 |
| | wax over base | | | | | | | |
| | coating | | | | | | | |
| 13 | 0.5% WE-6 | 0.25 | 9.4 | 2370 | 252.1 | 1.6 × 10¹¹ | 4.9 × 10¹⁰ | 32.7 |
| | wax over base | | | | | | | |
| | coating | | | | | | | |
| 14 | 1% Carnauba | 0.5 | 8.3 | 270 | 32.7 | *5.2 × 10¹² | ^{†}6.6 × 10¹¹ | — |
| | Wax over base | | | | | | | |
| | coating | | | | | | | |
| 15 | 1% Carnauba | 0.75 | 8.3 | 190 | 23 | *6.9 × 10¹² | ^{†}2.2 × 10¹² | — |
| | Wax over base | | | | | | | |
| | coating | | | | | | | |

*70° F./30% RH
^{†}70° F./60% RH

Table 7 shows the results of coating wax overcoats from organic solvents. The WE waxes are also soluble in organic solvents such as dichloromethane (DCM) and ethyl acetate. These solutions can be coated over the psuedo-boehmite layer and show improved surface resistivity along with good oil absorption.

TABLE 7
Wax Overcoats from Solvent Over Porous Alumina (90 parts 18N4-80 + 10 parts KH-20)

| | | Aim | | | Specific | Surface | Surface |
|---|---|---|---|---|---|---|---|
| | | Coverage of | Total | Oil | Capacity | Resistivity | Resistivity |
| Coating | Description | Layer | Thickness | Capacity | (mg/sq | (ohms/sq) | (ohms/sq) |
| Number | of Wax | (microns) | (microns) | (mg/sq m) | m/micron) | (70° F./30% RH) | (70° F./60% RH) |
| 16 | base | 15.0 | 9.04 | 2340 | 258.7 | 5.5 × 10¹¹ | 2.2 × 10¹¹ |
| | coating | | | | | | |
| 17 | WE-4 wax | 0.500 | 9.31 | 1920 | 206.2 | 3.4 × 10¹² | 1.2 × 10¹² |
| | in DCM | | | | | | |
| 18 | WE-4 wax | 0.750 | 9.52 | 1950 | 204.8 | 4.5 × 10¹² | 1.3 × 10¹² |
| | in DCM | | | | | | |
| 19 | WE-6 wax | 0.500 | 9.84 | 2100 | 213.3 | 2.3 × 10¹² | 5.6 × 10¹¹ |
| | in DCM | | | | | | |
| 20 | WE-6 wax | 0.750 | 8.78 | 2160 | 246.0 | 1.9 × 10¹² | 1.2 × 10¹² |
| | in DCM | | | | | | |
| 21 | WE-5 wax | 0.500 | 9.84 | 2030 | 206.2 | 1.4 × 10¹² | 6.6 × 10¹¹ |
| | in Ethyl | | | | | | |
| | Acetate | | | | | | |
| 22 | WE-5 wax | 0.750 | 9.58 | 1530 | 159.8 | 5.3 × 10¹² | 1. × 10¹² |
| | in Ethyl | | | | | | |
| | Acetate | | | | | | |

Several of the above formulations containing the waxes were fashioned into continuous webs and placed into a NexPress 2100 printer for testing as paper transport webs. The results are summarized in Table 8. All of these pseudo-boehmite overcoats had much better oil absorption than the uncoated NexPress transport web. Residual fuser oil on the uncoated transport web results in unwanted image artifacts on the prints. However, the NexPress web was readily cleaned of toner by the cleaning blade. Additionally, two resin coated papers had good tack down to the uncoated web. These were assigned readings of 10 in the tack down test, which is done by sliding the paper off the web after the wab is stopped for 10 seconds. The good tack down of the receivers to the uncoated NexPress web is probably due to the high surface resistivity of greater than 10¹⁴ ohms/sq. The web is poly(ethylene terephthalate).

The coated web with 6 parts (5.7 wt. %) ZONYL™ FSN had good cleaning but the paper tack down was poor, with values of 4 and 8. This is probably associated with the lower surface resistivity of 9.78×10⁹ ohm/sq at 72° F./45% RH. The oil absorption is very good. Tables 1-4 show that reducing the level of ZONYL™ FSN improves the tack down of the receivers to the coated web, but also causes the cleaning properties to get worse. A direct correlation is observed between higher levels of ZONYL™ FSN in the pseudo-boehrnite coating and lower web voltages after 30 seconds. High humidity results in lower web voltages after 30 seconds for a 6 parts ZONYL™ FSN pseudo-boehmite web.

The remaining waxes all show good resistivity and improved paper tack down, but fail to clean as well as the aqueous WE-5 coating. This may be due to the coating technique that was used and not necessarily the fact that the waxes were from organic solvents.

From the above results, the present invention is a transport member for transporting said receiver to or from said fuser assembly. The transport member includes a substrate bearing an oil-absorbing layer that has the following properties; a resistivity from 10¹⁰ to 10¹⁴ ohms/sq, a porosity of from 200 to 300 mg/m²/micron, a contact angle with release oil of from 20 to 40 degrees and an aluminum 2p relative atom percent coverage of from 10 to 25.

TABLE 8
Comparison of Uncoated and Coated Webs in a NexPress 2100 Printer at
70° F./30% RH

| | | | Paper Tack down | | | |
|---|---|---|---|---|---|---|
| | | | Force after 10 sec | | Post-Tack down | |
| | | | (1 = worst, | | Web Voltage | |
| Coating | Description | | 10 = best) | | (Decay) | |
| Number | of Wax | Cleaning | 60 gsm | 118 gsm | After 30 sce | Δ Volts |
| NexPress | No Coating | Good | 10 | 10 | −750 | 0 |
| Transport | (PET) | | | | | |
| Web | | | | | | |
| 23 | base coating + | Good | 4 | 8 | −420 | +560 |
| | 6% ZONLY ™ | | | | | |
| | FSN | | | | | |
| 24 | 0.5 micron WE-5 | Good | 4 | 10 | −1240 | −380 |
| | wax over base | | | | | |
| | coating | | | | | |
| 25 | 0.5 micron WE-4 | Poor | 8 | 10 | −1180 | −380 |
| | wax over base | | | | | |
| | coating | | | | | |
| 26 | 0.75 micron WE-4 | Poor | 7 | 10 | −1120 | −280 |
| | wax over base | | | | | |
| | coating | | | | | |
| 27 | 0.5 micron WE-6 | Poor | 7 | 10 | −1140 | −400 |
| | wax over base | | | | | |
| | coating | | | | | |
| 28 | 0.75 micron WE-6 | Poor | 7 | 10 | −1140 | −280 |
| | wax over base | | | | | |
| | coating | | | | | |
| 29 | 0.75 micron | Poor | 6 | 9 | −940 | −140 |
| | Carnauba Wax | | | | | |
| | over base | | | | | |
| | coating | | | | | |

The invention has been described in detail with particular reference to certain preferred embodiments thereof, but it will be understood that variations and modifications can be effected within the spirit and scope of the invention.

It is claimed:

1. An electrostatographic reproduction apparatus comprising:
a primary imaging member for producing an electrostatic latent image on a receiver;
a development station for applying toner particles to said latent image, thereby forming a developed toner image on said receiver;
a fuser assembly for fixing said developed toner image, thereby forming a fused toner image on said receiver;
a transport member for transporting said receiver to or from said fuser assembly, said transport member comprising a substrate bearing an oil-absorbing layer that comprises transparent aluminum inorganic particles comprising pseudo-boehmite, dispersed in an organic binder;
and a wax having a melting point less the 100° C.

2. The electrostatographic reproduction apparatus of claim 1, wherein said transparent aluminum inorganic particles comprise a dispersed particle size of less than 0.5 microns.

3. The electrostatographic reproduction apparatus of claim 1, wherein said organic binder is selected from the group consisting of starch or a modification product thereof, poly(vinyl alcohol) or a modification product thereof, cellulose derivatives, ether-substituted poly(phosphazenes), ether-substituted acrylates, ethylene oxide-vinyl alcohol copolymers, poly(vinyl butyral), poly(vinyl formal), polyoxazolines, aliphatic polyamides, poly(vinylpyrrolidone), and mixtures thereof.

4. The electrostatographic reproduction apparatus of claim 1, wherein said oil-absorbing layer includes said organic binder in an amount of about 3 wt. % to about 30 wt. % of said inorganic particles.

5. The electrostatographic reproduction apparatus of claim 1, wherein said oil-absorbing layer comprises pseudo-boehmite and poly(vinyl alcohol) in a weight ratio of about 3:1 to about 20:1.

6. The electrostatographic reproduction apparatus of claim 1, wherein said transport bearing said oil-absorbing layer is selected from the group consisting of a continuous web, a drum, and a roller.

7. The electrostatographic reproduction apparatus of claim 1, wherein said oil-absorbing layer further comprises a fluorosurfactant.

8. The electrostatographic reproduction apparatus of claim 7, wherein said fluorosurfactant is a water-soluble, ethoxylated nonionic fluorosurfactant.

9. The electrostatographic reproduction apparatus of claim 7, wherein said oil-absorbing layer contains said fluorosurfactant in an amount of about 0.01 wt. % to about 2 wt. % of the total amount of said inorganic particles and said organic binder.

10. The electrostatographic reproduction apparatus of claim 1, wherein said development station comprises a plurality of separate developing devices to enable full color image reproduction.

11. The electrostatographic reproduction apparatus of claim 1, wherein said transport member is adapted for duplex printing.

12. The electrostatographic reproduction apparatus of claim 1, wherein said oil-absorbing layer further comprises matte beads.

13. The electrostatographic reproduction apparatus of claim 1, wherein said oil-absorbing layer further comprises a crosslinking agent.

14. The electrostatographic reproduction apparatus of claim 1, wherein said wax comprises a fatty acid ester wax.

15. The electrostatographic reproduction apparatus of claim 1, wherein said wax comprises Carnauba wax.

16. The electrostatographic reproduction apparatus of claim 1, wherein said transport member comprises a polyethylene terephthalate.

17. An electrostatographic reproduction apparatus comprising:
a primary imaging member for producing an electrostatic latent image on a receiver;
a development station for applying toner particles to said latent image, thereby forming a developed toner image on said receiver;
a fuser assembly for fixing said developed toner image, thereby forming a fused toner image on said receiver; and
a transport member for transporting said receiver to or from said fuser assembly, said transport member bearing an oil-absorbing layer, said oil-absorbing layer comprising a resistivity of from 10¹⁰ to 10¹⁴ ohms/sq, a porosity of from 200 to 300 mg/m²/μm, a contact angle with release oil of from 20 to 40 degrees, and an aluminum 2p relative atom percent coverage of from 10 to 25.

18. The electrostatographic reproduction apparatus of claim 17, wherein said oil-absorbing layer comprises transparent aluminum inorganic particles comprising pseudo-boehmite, dispersed in an organic binder, and a wax having a melting point less the 100° C.
